(19) United States
(12) Patent Application Publication
(10) Pub. No.: US 2021/0008981 A1
(43) Pub. Date: Jan. 14, 2021

(54) CONTROL DEVICE, DISPLAY DEVICE, DISPLAY SYSTEM, MOVING BODY, CONTROL METHOD, AND RECORDING MEDIUM

(71) Applicants: Yuuki SUZUKI, Kanagawa (JP); Hiroshi YAMAGUCHI, Kanagawa (JP)

(72) Inventors: Yuuki SUZUKI, Kanagawa (JP); Hiroshi YAMAGUCHI, Kanagawa (JP)

(21) Appl. No.: 16/982,778

(22) PCT Filed: Mar. 26, 2019
(86) PCT No.: PCT/JP2019/013018

§ 371 Date: Sep. 21, 2020

(30) Foreign Application Priority Data
Mar. 28, 2018 (JP) 2018-063050
Mar. 18, 2019 (JP) 2019-050378

(51) Int. Cl. B60K 35/00; G09G 5/10

(52) U.S. Cl. CPC B60K 35/00; G09G 5/10; G09G 2360/141; G09G 2380/10; B60K 2370/1529; B60K 2370/349; G09G 2320/0626

(57) ABSTRACT

A control device, which controls a display of an image to be displayed at a position where the image is overlapped on an environment outside a moving body from a view of an occupant of the moving body, is disclosed. In the control device, a display part changes between a first case and a second case in response to brightness outside the moving body. In the first case, at least a part of the image is displayed with a first brightness and in a first display mode, and in the second case, at least a part of the image is displayed with a second brightness and in a second display mode.

### TECHNICAL FIELD

The present disclosure relates to a control device, a display device, a display system, a moving body, a control method, and a recording medium.

### BACKGROUND ART

Conventionally, in a moving body (moving device) such as a vehicle, a ship, an aircraft, and an industrial robot that moves while carrying an occupant such as a driver, it is known to use a head-up display (HUD: Head-Up Display) that displays an object for providing information to an occupant. In this HUD, for example, a display image light is reflected by a windshield or a combiner so as to be viewed by an occupant of the moving body.

In this HUD, in order to improve visibility of an object to be displayed, there is a technology for adjusting a display brightness or the like of the object (for instance, refer to PLT 1).

### CITATION LIST

### Patent Literature

[PTL 1] Japanese Unexamined Patent Publication No. 2009-199082

### SUMMARY OF INVENTION

### Technical Problem

However, in a related art, when brightness of an object is changed according to, for example, brightness of the background or importance of the object, there is a problem that a display of the object may be difficult to see. Therefore, the objective is to improve it aims at improving the visibility of an object.

### Solution to Problem

An aspect in the present disclosure provides a control device for controlling a display of an image to be displayed at a position where the image is overlapped on an environment outside a moving body from a view of an occupant of the moving body, including: a display part configured to change between a first case and a second case in response to brightness outside the moving body, the first case for displaying at least a part of the image with a first brightness and in a first display mode, the second case for displaying at least a part of the image with a second brightness and in a second display mode.

### Advantageous Effects of Invention

According to the disclosed technology, it is possible to improve visibility of an object.

### BRIEF DESCRIPTION OF DRAWINGS

FIG. 1A is a diagram illustrating an example of a system configuration of a display system according to the embodiment;

FIG. 1B is a diagram illustrating an example of an arrangement of the display system according to the embodiment;

FIG. 1C is a diagram illustrating an example of a range, in which an image is projected by the display device according to the embodiment;

FIG. 2A is a diagram illustrating an example of a hardware configuration of the display device according to the embodiment;

FIG. 2B is a diagram illustrating an example of a hardware configuration of an optical section of the display device according to the embodiment;

FIG. 3 is a diagram illustrating examples of functional blocks of the display device according to the embodiment;

FIG. 4 is a flowchart for explaining a process of the display device according to the embodiment;

FIG. 5 is a diagram for explaining an example of changing brightness of an object with respect to brightness of a background;

FIG. 6A is a diagram for explaining a process of changing a display mode of a predetermined object;

FIG. 6B is a diagram for explaining the process of changing the display mode of the predetermined object;

FIG. 6C is a diagram for explaining the process of changing the display mode of the predetermined object;

FIG. 6D is a diagram for explaining the process of changing the display mode of the predetermined object; and

FIG. 6E is a diagram for explaining the process of changing the display mode of the predetermined object.

### DESCRIPTION OF EMBODIMENT

In the following, an embodiment according to the present invention will be described with reference to the accompanying drawings.

### System Configuration

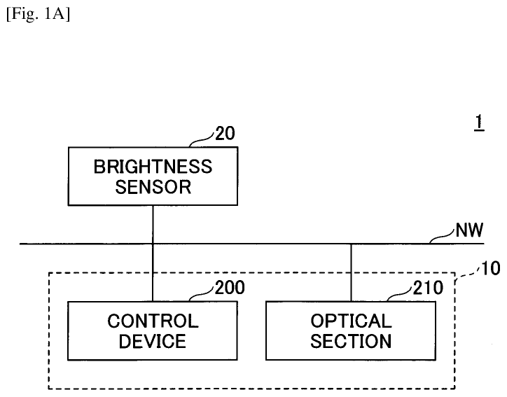

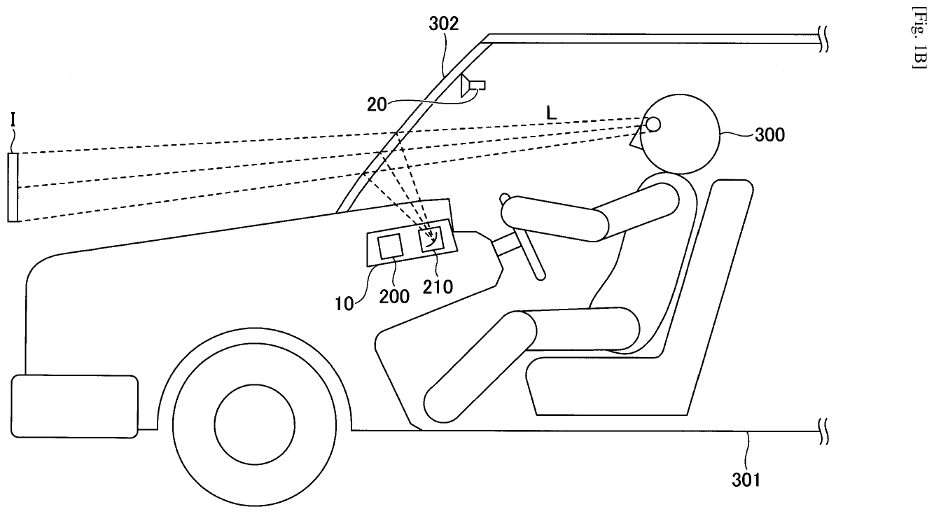

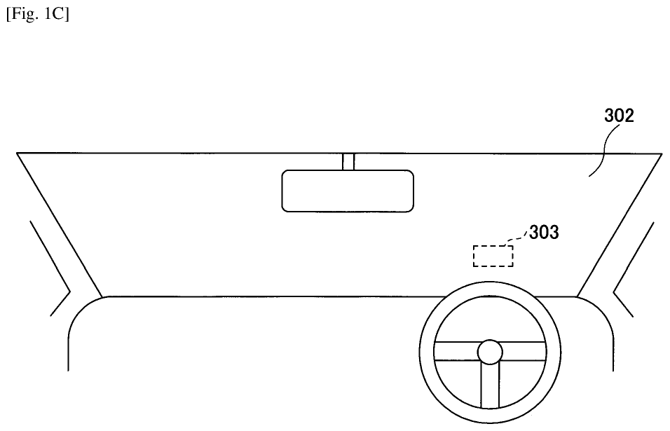

First, a system configuration of a display system according to the present embodiment will be described with reference to FIG. 1A to FIG. 1C. FIG. 1A is a diagram illustrating an example of a system configuration of the display system according to the embodiment. FIG. 1B is a diagram illustrating an example of an arrangement of the display system according to the embodiment.

As illustrated in FIG. 1A, in a display system 1 according to the embodiment, the display system 1 includes a display device 10 and a brightness sensor 20 (an example of “a sensor for detecting an external brightness”). The display device 10 includes a control device 200 and an optical section 210. The brightness sensor 20, the control device 200, and the optical section 210 may be connected via an in-vehicle network NW such as a controller area network (CAN) bus, for example.

As illustrated to FIG. 1B, the display system 1 according to the embodiment is mounted in a moving body, such as a vehicle, a ship, an aircraft, a personal mobility, an industrial robot, and the like. In addition, an example will be described in a case of mounting the display system 1 in a vehicle; however, the display system 1 is also applicable to any moving body besides the vehicle. The vehicle may be, for example, an automobile, a motorbike, a light vehicle, a railway vehicle, or the like.

The display device 10 is, for example, a device such as a Head-Up Display (HUD), a head mounted display (HMD), or the like. In the following, a case, in which the display device 10 is the HUD for displaying a virtual image, is described as an example. The display device 10 is installed, for example, in a dashboard of a vehicle 301. Projection light L, which is image light emitted from the display device 10, is reflected at a windshield 302 as a transmission/reflection member, and travels toward an occupant 300 who is a viewer. Here, the transmission/reflection member is, for example, a member that transmits a part of light and reflects a part of the light. By this member, an image is projected on the windshield 302, and the occupant 300 is able to visually superimpose an object (content) such as a figure, a character, an icon, or the like for a navigation on an environment outside the vehicle 301. A combiner as the transmission/reflection member may be installed on an inner wall surface or the like of the windshield 302 so that a driver is able to visually recognize an virtual image I by the projection light L reflected at the combiner.

FIG. 1C is a diagram illustrating an example of a range, in which an image is projected by the display device according to the embodiment. The display device 10 projects an image on a projection range 303 in the windshield 302, for example, as illustrated to FIG. 1C.

The brightness sensor 20 is a sensor for detecting the brightness of a front of the vehicle 301 or the like. The brightness sensor 20 may be provided, for example, at a top portion of the windshield 302, or may be provided on a periphery of the display device 10 near the dashboard. Moreover, the brightness sensor 20 may be a camera or the like for measuring an inter-vehicle distance between a vehicle ahead and the vehicle 301 for automatic driving.

### Hardware Configuration

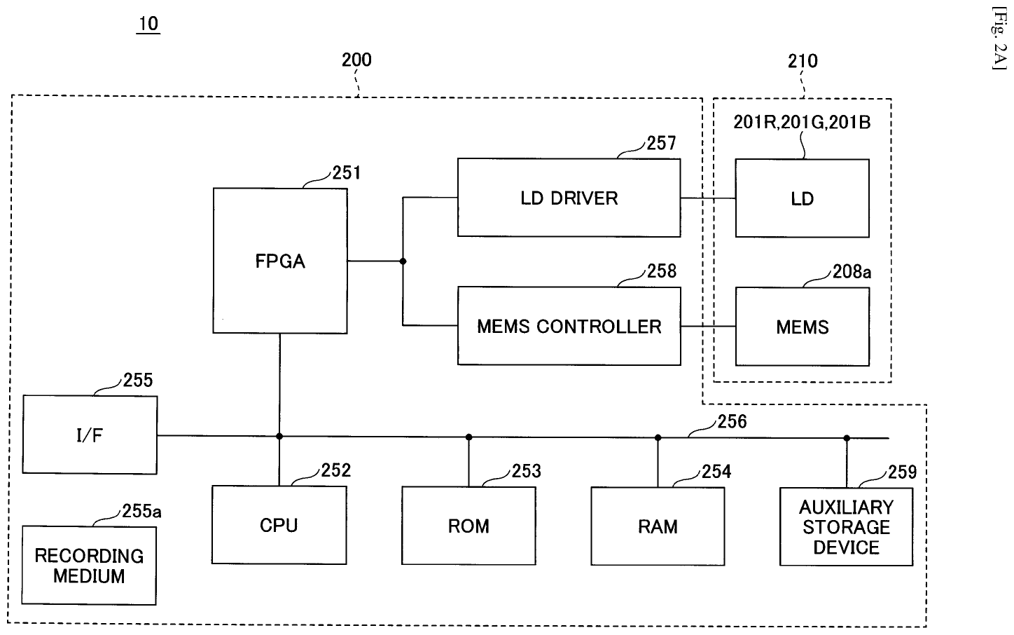

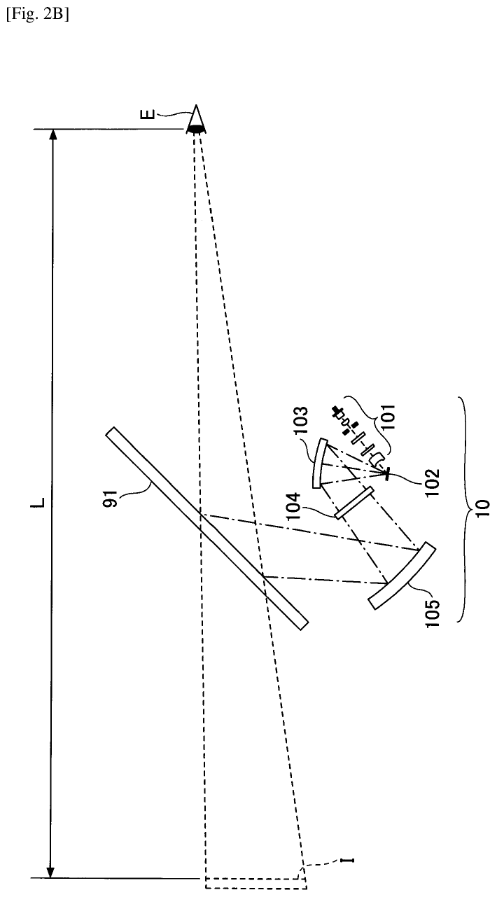

Next, a hardware configuration of the display device 10 according to the embodiment will be described with reference to FIG. 2A and FIG. 2B. FIG. 2A is a diagram illustrating an example of the hardware configuration of the display device according to the embodiment.

The display device 10 includes the control device 200 and the optical section 210. The control device 200 includes an field-programmable gate array (FPGA) 251, a central processing unit (CPU) 252, a Read Only Memory (ROM) 253, a Random Access Memory (RAM) 254, an interface (hereafter, referred to as an I/F) 255, a bus line 256, an LD driver 257, a Micro Electro Mechanical Systems (MEMS) controller 258, and an auxiliary storage device 259. The FPGA 251 controls laser light sources 201R, 201G, and 201B of a light source unit in the optical section 210 by the LD driver 257, and controls a MEMS 208a being a light scanning device of the optical section 210 by the MEMS controller 258. The CPU 252 controls each function of the display device 10. The ROM 253 stores various programs such as a program (image processing program) and other programs executed by the CPU 252 to control each function of the display device 10.

In response to an instruction to start the program, the RAM 254 reads out a program from the ROM 253 or the auxiliary storage device 259, and stores the program. The CPU 252 implements a function related to the display device 10 in accordance with the program stored in the RAM 254.

The I/F 255 is an interface for communicating with an external controller and the like, and is connected to, for example, a vehicle navigation device, various sensor devices, and the like via a Controller Area Network (CAN) of the vehicle 301. Moreover, the brightness sensor 20 for detecting the brightness through the windshield 302 is connected to the I/F 255.

The display device 10 is able to read data from and write data to a recording medium 255a via the I/F 255. An image processing program for realizing a process in the display device 10 may be provided by the recording medium 255a. In this case, the image processing program is installed in the auxiliary storage device 259 via the I/F 255 from the recording medium 255a. However, an installation of the image processing program may not be performed always from the recording medium 255a, and may be downloaded from another computer via a network. The auxiliary storage device 259 stores the installed image processing program and also stores necessary files, data, and the like.

For example, the recording medium 255a may be a portable recording medium such as a flexible disk, a Compact Disk Read Only Memory (CD-ROM), a Digital Versatile Disc (DVD), an SD memory card, or a Universal Serial Bus (USB) memory. Also, for example, the auxiliary storage device 259 may be an HDD (Hard Disk Drive), a flash memory, or the like. The recording medium 255a and the auxiliary storage device 259 correspond to computer readable recording media. In FIG. 2A, a portion including the CPU 252, the ROM 253, the RAM 254, the I/F 255, the bus line 256, and the auxiliary storage device 259 may be also referred to as an image processing apparatus or an information processing apparatus (computer).

In a case in which a display part 14 described later changes the brightness (luminance) of an object, which is at least a part of an image to be displayed, when changing a luminance value alone of image data to be displayed as an image, instead of controlling a light amount output by the light source unit or the like of the optical section 210, the control device 200 may not include the LD driver 257 and the MEMS controller 258.

### Hardware Configuration of the Optical Section 210

FIG. 2B is a diagram illustrating an example of a hardware configuration of the optical section of the display device according to the embodiment. The optical section 210 mainly includes a light source section 101, an optical deflector 102, a mirror 103, a screen 104, and a concave mirror 105.

The light source section 101 includes, for example, three laser light sources (hereafter, LDs: laser diodes) corresponding to RGB, a coupling lens, an aperture, a combining element, a lens, and the like, combines laser beams emitted from the three LDs, and guides the combined laser beams toward a reflection surface of the optical deflector 102. The laser beam guided to the reflection surface of the optical deflector 102 is two-dimensionally deflected by the optical deflector 102.

As the optical deflector 102, for example, one micro mirror oscillating around two orthogonal axes, or two micro mirrors oscillating around or rotating around one axis may be used. The optical deflector 102 may be, for example, a Micro Electro Mechanical Systems (MEMS) mirror manufactured by a semiconductor process or the like. The optical deflector 102 can be driven, for example, by an actuator that uses a deformation force of a piezoelectric element as a driving force. As the optical deflector 102, a galvano mirror, a polygonal mirror or the like may be used.

A laser beam two-dimensionally deflected by the optical deflector 102 is incident on the mirror 103, is returned back by the mirror 103, and renders a two-dimensional image (intermediate image) on a surface (a surface to be scanned) of the screen 104. For example, a concave mirror may be used as the mirror 103, and a convex mirror or a plane mirror may be also used as the mirror 103.

As the screen 104, it is preferable to use a microlens array or a micro mirror array having a function of causing a laser beam to diverge at a desired divergence angle; however, a diffusion plate for diffusing a laser beam, a transmission plate or a reflection plate with a smooth surface, or the like may be used.

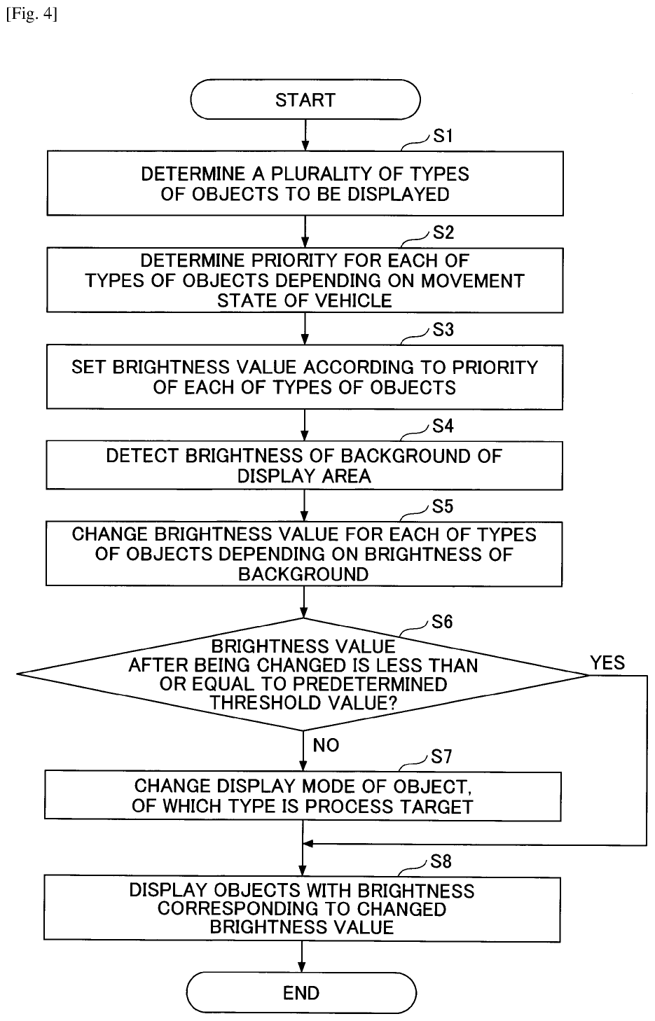

The laser beam emitted from the screen 104 is reflected by the concave mirror 105, and is projected onto a front windshield 91. The concave mirror 105 has a function similar to that of a lens, and has a function of forming an image at a predetermined focal length. Therefore, the virtual image I is displayed at a position determined by the distance between the screen 104 corresponding to a physical object and the concave mirror 105 and by the focal distance of the concave mirror 105. In FIG. 4, since the laser beam is projected onto the front windshield 91 by the concave mirror 105, a virtual image I is displayed (imaged) at a distance L from a viewpoint E of a driver V.

At least a portion of a light flux to the front windshield 91 is reflected toward the viewpoint E of the driver V. As a result, the driver V is able to visually recognize the virtual image I, in which the intermediate image of the screen 104 is enlarged through the front windshield 91. That is, the intermediate image is enlarged and displayed as the virtual image I through the front windshield 91 as viewed from the driver V.

### Functional Configuration

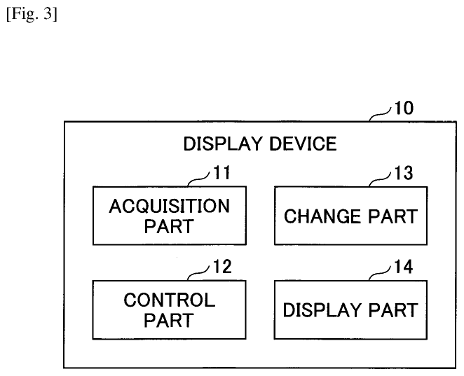

Next, a functional configuration of the display device 10 according to the embodiment will be described with reference to FIG. 3. FIG. 3 is a diagram illustrating examples of functional blocks of the display device according to the embodiment.

The display device 10 includes an acquisition part 11, a control part 12, a change part 13, and a display part 14. These parts are realized by processes, which one or more programs installed in the display device 10 cause the CPU 252 of the display device 10 to execute. Alternatively, the change part 13 and the display part 14 may be realized by processes conducted by the CPU 252, the FPGA 251, the LD driver 257, and the MEMS controller 258, which are illustrated in FIG. 2A, in cooperation with each other.

The acquisition part 11 acquires various information from an external device, such as the brightness in front of the vehicle 301 detected by the brightness sensor 20.

The control part 12 guides a route from a current location of the vehicle 301 to a destination defined beforehand. The control part 12 causes the display part 14 to display an object indicating a traveling direction of the route, such as right turn or left turn, for example. The object is at least a part of an image generated and displayed by the control part 12.

In addition, the control part 12 displays a number or the like indicating a vehicle speed (speed) of the vehicle 301 on a background in front of the vehicle 301. Here, the display device 10 may acquire information on the vehicle speed of the vehicle 301 from, for example, an Electronic Control Unit (ECU) of the vehicle 301.

The change part 13 determines (changes) the brightness (luminance) of the object in accordance with the brightness (luminance) outside the vehicle 301, a movement state of the vehicle 301, and the like. The movement state of the vehicle 301 is information of a state, which changes according to a movement (traveling) of the vehicle 301. The movement state of the vehicle 301 includes, for example, the vehicle speed of the vehicle 301, a state between a position to turn right, turn left, change a lane, or the like and the current location of the vehicle 301 in the route from the current location of the vehicle 301 to the destination, a state of a physical object existing in front of the vehicle 301, and the like.

Depending on the brightness outside the vehicle 301, the display part 14 displays an object by switching between a case of displaying the object with a first brightness and in a first display mode and a case of displaying the object with a second brightness brighter than the first brightness and in a second display mode different from the first display mode. More specifically, in a case in which brightness changed by the change part 13 is lower than or equal to a predetermined threshold, the display part 14 displays the object with the brightness changed by the change part 13 (an example of the “first brightness”) in a normal display mode (an example of the “first display mode”) defined beforehand. Also, in a case in which the brightness changed by the change part 13 is not lower than or equal to the predetermined threshold, the display part 14 displays the object in a further emphasized display mode (an example of the “second display mode”) with brightness lower than or equal to the predetermined threshold (an example of the “second brightness”).

The display part 14 may change the brightness of the object by, for example, changing luminance (luminance value) of image data generated by the control part 12.

Moreover, for example, in a case in which the display device 10 is the HUD using a laser light source, the display part 14 may change the brightness of the object to be displayed by adjusting current or the like, which is fed to the laser of the light source unit of the optical section 210 to adjust an output amount (light amount) of the laser. Moreover, for example, in a case of the HUD in which the display device 10 uses a liquid crystal display as the light source, the display device 10 may change the brightness of the object to be displayed, by adjusting the brightness of the backlight of the liquid crystal display.

### Process

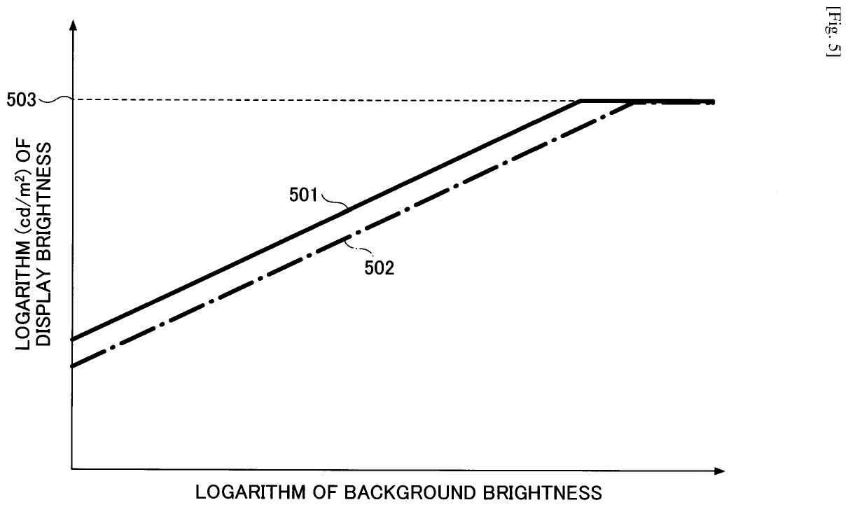

Next, a process of the display device 10 will be described according to the embodiment with reference to FIG. 4. and FIG. 5. FIG. 4 is a flowchart for explaining the process of the display device according to the embodiment. FIG. 5 is a diagram for explaining an example of changing brightness of an object with respect to brightness of the background. The process explained in FIG. 4 may be performed at predetermined intervals, for example, 30 times per second.

In step S1, the control part 12 determines a plurality of types of objects to be displayed according to the movement state of the vehicle 301 and the like. Here, it is determined that an object indicating the current vehicle speed of the vehicle 301, an object for guiding a route from the current location of the vehicle 301 to a preset destination, an object indicating a physical object in front of the vehicle 301 are determined to be the objects of the type to be displayed.

Subsequently, the change part 13 determines a priority (importance) for each of objects depending on the movement state of the vehicle 301 (step S2). For example, in a case of simultaneously displaying an object indicating a vehicle speed and an object for navigation, when a moving body approaches a branch point such as an intersection, the object for navigation with high importance is emphasized and displayed. In this case, for example, by setting the brightness of the object for navigation to be higher than the brightness of the object indicating the vehicle speed, the object for navigation is emphasized and displayed.

Here, for example, in a case in which the current location of the vehicle 301 is within a predetermined distance from the intersection or the like included in the route, the change part 13 may set the priority of the object for guiding the route higher than that at a normal time; in a case in which the distance is not within the predetermined distance and after passing through the intersection or the like, the change part 13 may set the priority of the object back to that of the normal time. Alternatively, in a case in which the current location of the vehicle 301 reaches a point of predetermined distance from the intersection or the like included in the route, the change part 13 may set the priority of the object for guiding the route higher than that of the normal time; when the vehicle 301 passes the point, the change part 13 may set the priority of the object back to that of the normal time.

Also, for example, when detecting, based on an image of a camera or the like, a physical object such as another vehicle, an object such as a pedestrian, or the like that may collide with the vehicle 301 in front of the vehicle 301, the change part 13 sets the priority of the object indicating the physical object in front of the vehicle 301 higher than that of the normal time.

Moreover, in a case in which the current vehicle speed of the vehicle 301 exceeds a speed limit of the road, on which the vehicle 301 is traveling, by a predetermined value (for example, 20 km/h) or more, the change part 13 sets the priority of the object indicating the current vehicle speed of the vehicle 301 to be higher than that at the normal time. Also, when the priority of an object of one type is set to be higher than that at the normal time, the change part 13 may set the priority of an object of another type lower than that at the normal time. By the process in step S2, it is possible to highlight and display an object of a type considered to be important to the occupant of the vehicle 301.

Furthermore, determination of the importance may be performed by an apparatus different from the display device 10, such as another ECU, for example. In this case, for example, the acquisition part 11 may acquire a result of the determination of the importance.

Subsequently, the change part 13 sets the brightness value according to the priority of each of various types of objects (step S3). Here, the change part 13 sets the brightness value to be greater as the priority is higher.

Subsequently, the change part 13 detects the brightness of the background of the display area of the display device 10 (step S4). Here, for example, based on the data of the brightness sensor 20 acquired by the acquisition part 11, the change part 13 detects the brightness of the background.

Subsequently, the change part 13 changes the brightness value for each of types of objects depending to the brightness of the background (step S5). Here, as the brightness of the background is brighter, the change part 13 sets the brightness value of each of types of the other objects higher.

For example, by the processes from steps S2 to S5, the change part 13 changes the object with a normal priority to a brightness value, which is easy for the occupant to visually recognize and does not cause glare for the occupant with respect to a brightness of the background. The change part 13 may set the brightness value to a value substantially linear with respect to the background brightness on a logarithmic axis where a vertical axis represents the logarithm of a display luminance (brightness) of an object and a horizontal axis represents a logarithm of the background brightness. Also, the change part 13 changes brightness of an object whose priority is higher than that of the normal time to be brighter than that of the normal time.

The change part 13 executes processes from steps S6 to S8 described below for each type of object. Therefore, in the following, one of the types of objects is referred to as “type of processing target”. Note that the change part 13 may execute the processes from steps S6 to S8 for each object.

Subsequently, the change part 13 determines whether or not the brightness value after being changed is less than or equal to a predetermined threshold value for the object of the type to be processed (step S6). Here, the change part 13 may use a value corresponding to an upper limit value of the brightness, which is able to be displayed on the display device 10 due to a restriction of hardware of the display device 10 or the like, as the predetermined threshold value. Alternatively, the change part 13 may use the upper limit value of the brightness set for the occupant or the like of the vehicle 301 as the predetermined threshold value.

When the brightness value after the change is less than or equal to the predetermined threshold (YES in step S6), the process proceeds to step S8. When the brightness value after the change is not less than or equal to the predetermined threshold (NO in step S6), the change part 13 changes the display mode of the object, of which the type is a process target (step S7). A process of changing the display mode will be described later.

Subsequently, the display part 14 displays various types of objects with brightness corresponding to the changed brightness value (step S8), and ends the process. In FIG. 5, in a graph, in which a vertical axis represents a logarithm of the display luminance (brightness) of the object and a horizontal axis represents a logarithm of the background luminance, a case, in which a line 501 indicating brightness of an object whose priority is higher than that of the normal time, and a line 502 indicating brightness of an object when the priority is normal, is illustrated.

As illustrated in FIG. 5, when the brightness value of the object changed by the processes from step S2 to step S5 is less than or equal to a predetermined threshold 503, with respect to the logarithm of the background brightness, the brightness is displayed with linearly increasing values as the line 501 and the line 502. Then, when the value of the brightness of the object changed by the processing in step S2 to step S5 exceeds the predetermined threshold 503, an object is displayed with the brightness of the predetermined threshold 503.

### Change Process of Display Mode

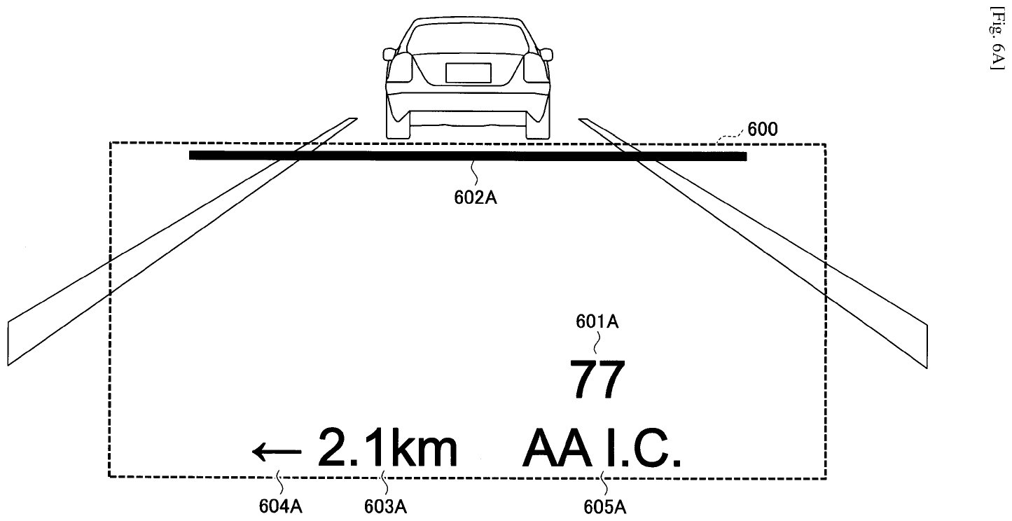

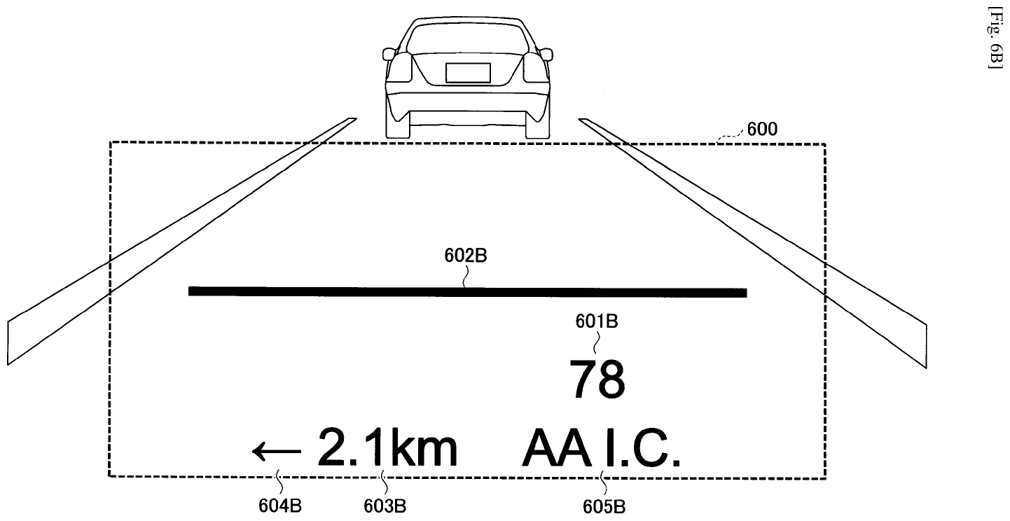

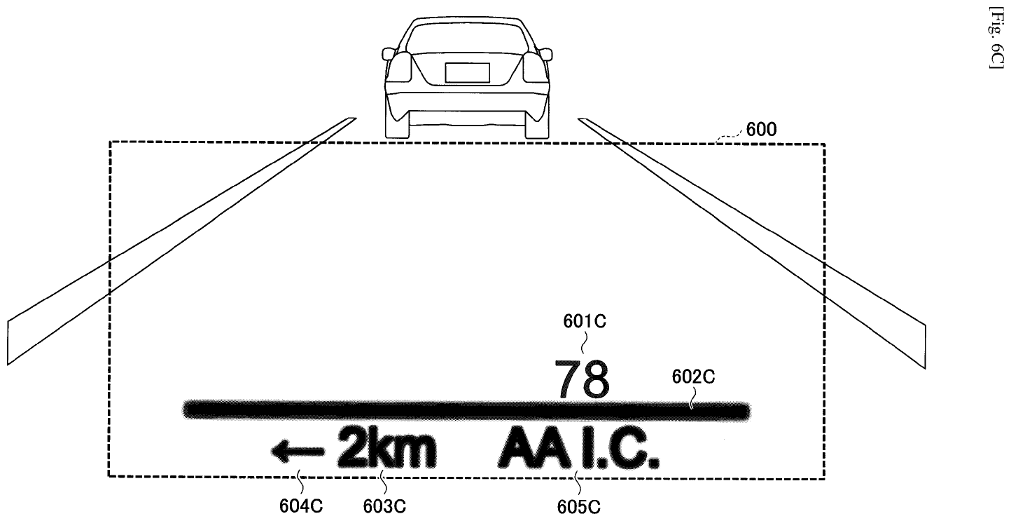

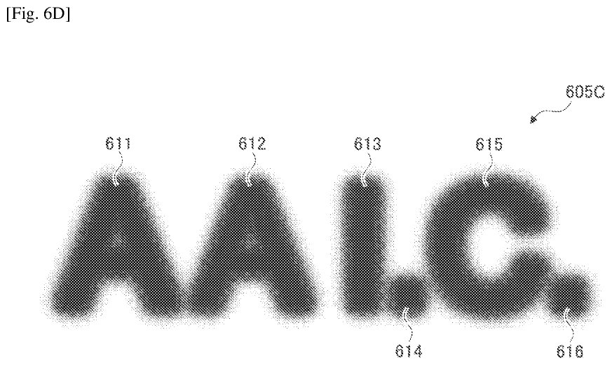

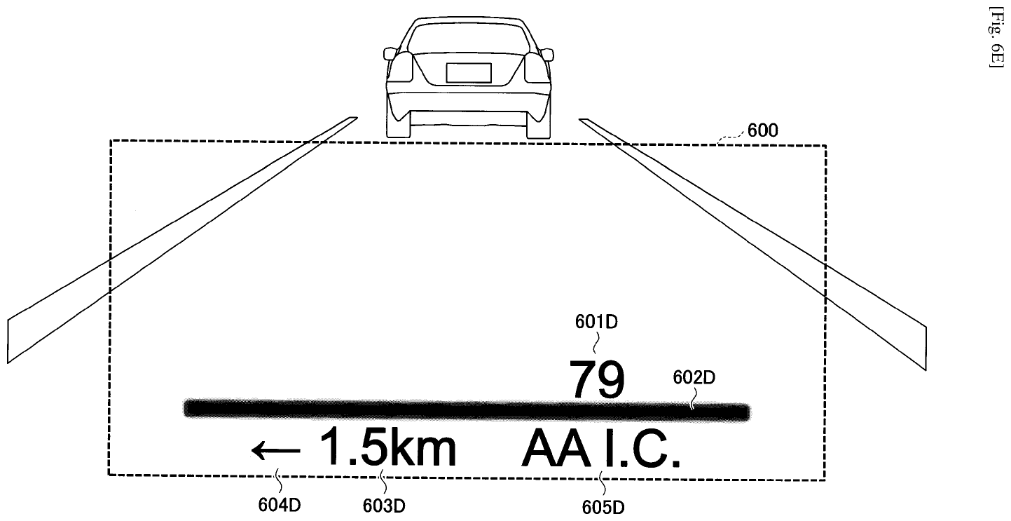

Next, a process of changing the display mode of a predetermined object by the change part 13 in step S7 in FIG. 4 will be described with reference to FIG. 6A to FIG. 6E. FIG. 6A to FIG. 6E are diagrams for explaining the process of changing the display mode of the predetermined object. In FIG. 6A and the like, it is assumed that for a greater color intensity, the brightness of the object becomes higher.

In an example of FIG. 6A, the display part 14 displays an object 601A indicating a current vehicle speed of the vehicle 301 and objects 602A, 603A, 604A, and 605A for guiding a route in a display area 600 (the projection range 303 of FIG. 1B) by the HUD.

The object 602A is an object, which indicates a second point, which is a point before a predetermined distance (for example, 2 km), from a first point, at which the traveling direction of the vehicle 301 changes in the route from the current location of the vehicle 301 to the predetermined destination. The first point corresponds to, for example, an intersection where a right turn, left turn, straight ahead, a lane change, or the like is made in the route, or a point to interchange. In the example of FIG. 6A, the display part 14 displays the object 602A at a position overlapping the second point in a real environment outside the vehicle 301.

The object 603A is an object, which indicates a distance between the current location of the vehicle 301 and the first point, and is displayed as “2.1 km” in the example of

FIG. 6A. The object 604A is the graphic object indicating that the user needs to turn left at the first point. The object 605A is a character object indicating a name of the first point, and is displayed as “AA I.C.” in the example of FIG. 6A.

FIG. 6B illustrates an example of a display screen displayed when the vehicle 301 travels several tens of meters after the display screen of FIG. 6A is displayed. In the example of FIG. 6B, the display part 14 displays an object 601B indicating the current vehicle speed of the vehicle 301 and objects 602B, 603B, 604B, and 605B for guiding the route, similar to the example of FIG. 6A. In the example of FIG. 6B, the display part 14 displays the object 601B indicating the current vehicle speed of the vehicle 301 and objects 602B to 605B for guiding the route, similar to the example of FIG. 6A. In the example of FIG. 6B, compared with the example of FIG. 6A, since the vehicle 301 is closer to the second point, the object 602B indicating the second point is displayed at a position lowered in a vertical direction. In the example of FIG. 6B, because the object 603B indicates a distance between the current location of the vehicle 301 and the first point in units of 0.1 km, a value of the object 603B does not change from the value indicated by the object 603A.

FIG. 6C illustrates an example of a display screen displayed when the vehicle 301 travels several tens of meters and reaches the second point after the display screen of FIG. 6B is displayed. In an example of FIG. 6C, similar to the example of FIG. 6A and FIG. 6B, the display part 14 displays an object 601C indicating the current vehicle speed of the vehicle 301, and objects 602C, 603C, 604C, and 605C (Hereinafter, also referred to as “object 605C and the like” as appropriate) for guiding the route. In the example of FIG. 6C, compared with the examples of FIG. 6A and FIG. 6B, because the vehicle 301 has reached the second point, the object 602C indicating the second point is displayed at a predetermined position in the vertical direction. In the example of FIG. 6C, the predetermined position is a position between the object 601C and the object 605C in the vertical direction (an example of the position according to the position of the object 605C or the like guiding a change in the traveling direction).

In the example of FIG. 6C, because the vehicle 301 has attained at the second point, the change part 13 changes the brightness of the objects 602C to 605C for guiding the route to be a high level in the processes of step S2 and step S3 of FIG. 4. Also, in the example of FIG. 6C, because the changed brightness value is not less than the predetermined threshold, the change part 13 changes the display modes of the objects 603C to 605C having a type guiding the route by the process of step S7 in FIG. 4.

FIG. 6D illustrates a display example of the object 605C in FIG. 6C as an example of the changed display mode. The display part 14 displays an area inside each of characters 611, 612, 613, 614, 615, and 616 included in the object 605C with the brightness of the predetermined threshold, as depicted in FIG. 6D. Furthermore, the display part 14 displays pixels having the same color tone as an outline of each of the characters 611 to 616 with brightness lower than the predetermined threshold and a color intensity lower than the internal area. As a result, with lines such as of characters themselves being displayed as in the normal time, the peripheral areas (corresponding to outlines) of the characters and the like are fuzzily displayed so as to appear enlarged. For this reason, it is possible to maintain a uniformity of color and to perform a highlighted display while preventing an area of a line of a character or the like from losing visibility due to overlapping.

FIG. 6E illustrates an example of a display screen displayed when the vehicle 301 further travels hundreds of meters, passes through the second point, and travels a point ahead of the second point, after the display screen of FIG. 6C is displayed. In the example of FIG. 6E, the display part 14 displays an object 601D indicating the current vehicle speed of the vehicle 301 and objects 602D to 605D for guiding the route, as in the examples of FIGS. 6A to 6C. In the example of FIG. 6E, an object 602D indicating the second point is fixed and displayed at the position of the object 602C of FIG. 6C. In the example of FIG. 6E, in a case in which the brightness changed by the change part 13 is no longer higher than the predetermined threshold value, for example, such as because the brightness of the background has decreased, the display part 14 displays the objects 603D to 605D for guiding the route in the normal display mode.

### Modification of Second Display Mode

The display part 14 may display the object 605C or the like in FIG. 6C in the following display mode, instead of or in addition to fuzzily displaying the periphery of the object 605C so as to appear enlarged. Moreover, the display part 14 may display the object 605C and the like in FIG. 6C by combining the following display modes.

The display part 14 may switch and display the brightness of the object 605C or the like in FIG. 6C continuously or discretely between the predetermined threshold and a value smaller than the predetermined threshold (for example, half the logarithm of the predetermined threshold). In a case of switching continuously, for example, the display part 14 may change the brightness of the object 605C or the like in FIG. 6C according to a sine wave of a predetermined cycle (for example, 1 second cycle) between the predetermined threshold and a value smaller than the predetermined threshold. As a result, it is possible to perform highlighting such as blinking while constantly displaying the object 605C and the like in FIG. 6C.

Alternatively, the display part 14 may display the object 605C and the like in one of a display mode for thickening a line width for each of characters such as the object 605C, a display mode for bordering the outline of the object 605C and the like, a display mode for changing the color tone of the object 605C and the like, a display mode for enlarging the object 605C, and the like.

### Modified Example of Change of Brightness

In a case in which the brightness after a change of the first type of object having a relatively high degree of importance is less than or equal to the above-described predetermined threshold value, the change part 13 changes the object of the second type, which has a relatively low degree of importance, to the first brightness, which is an original brightness. In a case in which the brightness after the change of the object of the first type is not less than the predetermined threshold value, the change part 13 may change the brightness of the object of the second type to a third brightness lower than the first brightness.

In this case, for example, in a case of displaying the display screen in FIG. 6C, when the brightness after the change of the object 605C or the like (an example of the “first type of object”) for guiding the route is not less than or equal to the above-described predetermined threshold value, the change part 13 changes the brightness of the object 601C (an example of the “second type of object”) indicating the current vehicle speed of the vehicle 301 to be lower than the original brightness. By this display control, when the brightness of the first type of object changed by the change part 13 is less than the threshold, the display part 14 displays the brightness of the second type of the object at the first brightness. When the brightness of the object of the first type is not less than the threshold, the display part 14 displays the brightness of the object of the second type at a third brightness lower than the first brightness. Accordingly, it is possible for the occupant to perceive the object 605C and the like more emphasized on the display screen depicted in FIG. 6C.

### Summary of the Embodiment

The brightness control of the HUD may be realized by, for example, a combination of hardware means for uniformly adjusting brightness of the entire screen and software means for changing a value of an input image signal of each image in the screen. For example, in the case of a liquid crystal system using a backlight as a light source, a changing of brightness of a backlight corresponds to hardware means, and a changing of an input image signal to a liquid crystal corresponds to software means.

In the HUD or the like, in a case of adjusting brightness of an object, when the environment outside the moving body is a snowy road, depending on brightness of a background displaying the object, the brightness of the background may exceed 10,000 cd/m². In this case, an upper limit of the brightness of the object is restricted by hardware. For example, in a case of a laser HUD, an upper limit corresponds to a value of an input image signal maximized by emitting light at an upper limit of an amount of current, which is fed to the laser. Also, in a case of a liquid crystal HUD, the upper limit corresponds to a case in which the value of the input image signal is maximized by emitting the backlight to the maximum.

Also, for example, in a case of simultaneously displaying an object indicating a vehicle speed and an object for navigation, when the moving body approaches a junction such as an intersection, it is also conceivable to display a more important navigation object for emphasis. In this case, for example, it is conceivable to emphasize and display an object for navigation by setting brightness of the object for navigation to be higher than brightness of the object indicating the vehicle speed.

As described above, when the brightness is changed according to the brightness of the background and the degree of importance, a display of an object may be difficult to see depending on the restriction by the hardware, a sensation of glare by the occupant, or the like.

According to the embodiment described above, when brightness of the object according to brightness of a background and the moving state is not less than a predetermined threshold value, the display device, which displays an object on an environment outside the moving body, changes a display mode and displays an object at a brightness lower than or equal to the predetermined threshold. Thereby, it is possible to improve visibility of the object.

In the embodiment described above, the brightness and the display mode are changed based on the priority or the importance; however, in a state of emphasizing a part of objects, the part of objects may be emphasized, regardless of the priority or the importance.

### Other

Note that each of functional parts of the display device 10 may be realized by cloud computing formed by one or more computers. Alternatively, at least one of the functional parts of the display device 10 may be formed as a separate device from a device having another functional part. In this case, for example, at least one of the control part 12 or the change part 13 may be included in an on-vehicle type or portable type navigation device, or a server device on the cloud computing. That is, the display device 10 includes a form configured by a plurality of devices. The change part 13 is an example of a “determination part”.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP, or 3G or 5G-compliant phone) and so on. Since the present invention can be implemented as software, each and every aspect of the present invention thus encompasses computer software implementable on a programmable device.

Although the present invention has been described above with reference to certain illustrative embodiments and examples, the present invention is not limited to these embodiments and examples, and numerous variations and modifications may be made without departing from the scope of the present invention.

The present application is based on and claims the benefit of priority of Japanese Priority Applications No. 2018-063050 filed on Mar. 28, 2018, and No. 2019-050378 filed on Mar. 18, 2019, with the Japanese Patent Office, the entire contents of which are hereby incorporated by reference.

### REFERENCE SIGNS LIST

1 display system

10 display device

11 acquisition part

12 control part

13 change part

14 display part

20 brightness sensor

200 control device

210 optical section

301 vehicle

302 windshield

1. A control device for controlling a display of an image to be displayed at a position where the image is overlapped on an environment outside a moving body from a view of an occupant of the moving body, comprising:
a display part configured to change between a first case and a second case in response to brightness outside the moving body, the first case being for displaying at least a part of the image with a first brightness and in a first display mode, and the second case being for displaying at least a part of the image with a second brightness and in a second display mode.

2. The control device as claimed in claim 1, further comprising a determination part configured to determine brightness of at least the part of the image depending on brightness outside the moving body,
wherein at least the part of the image is displayed with the first brightness and in the first display mode, in a case in which the brightness determined by the determination part is less than or equal to a predetermined threshold, and
wherein the display part displays at least a part of the image with the second brightness less than or equal to the predetermined threshold and in the second display mode emphasized more than the first display mode for the occupant, in a case in which in a case in which the brightness determined by the determination part is not less than or equal to a predetermined threshold.

3. The control device as claimed in claim 2, wherein the predetermined threshold is one of a value corresponding to an upper limit of brightness which a display device is able to display and a value defined as the upper limit.

4. The control device as claimed in claim 1, wherein the display part switches between the first case and the second case in response to a moving state of the moving body, the first case being for displaying at least the part of the image with the first brightness and in the first display mode, and the second case being for displaying at least the part of the image with the second brightness and in the second display mode.

5. The control device as claimed in claim 2, wherein the display part switches between the first case and the second case in response to a moving state of the moving body, the first case being for displaying at least the part of the image with the first brightness and in the first display mode, and the second case being for displaying at least the part of the image with the second brightness and in the second display mode.

6. The control device as claimed in claim 3, wherein the display part switches between the first case and the second case in response to a moving state of the moving body, the first case being for displaying at least the part of the image with the first brightness and in the first display mode, and the second case being for displaying at least the part of the image with the second brightness and in the second display mode.

7. The control device as claimed in claim 1, wherein the second display mode corresponds to a display mode for displaying an area inside at least the part of the image with the second brightness and displaying pixels in a color similar to that of an outline of the part of the image in a peripheral area of at least the part of the image.

8. The control device as claimed in claim 2, wherein the second display mode corresponds to a display mode for displaying an area inside at least the part of the image with the second brightness and displaying pixels in a color similar to that of an outline of the part of the image in a peripheral area of at least the part of the image.

9. The control device as claimed in claim 3, wherein the second display mode corresponds to a display mode, which displays an area inside at least the part of the image with the second brightness, and which displays pixels in a color similar to that of an outline of the part of the image in a peripheral area of at least the part of the image.

10. The control device as claimed in claim 7, wherein the second display mode corresponds to a display mode, which displays the area inside at least the part of the image with the second brightness, and which displays pixels in a color similar to that of an outline of the part of the image with applying at least one of brightness lower than the second brightness or density lower than the area inside at least the part of the image in a peripheral area of at least the part of the image.

11. The control device as claimed in claim 1, wherein the second display mode switches brightness of at least the part of the image between the second brightness and a value smaller than that of the second brightness.

12. The control device as claimed in claim 1, wherein the second display mode conducts one or more of a display mode for thickening a line width of a character corresponding to at least the part of the image, a display mode for bordering an outline of at least the part of the image, a display mode for changing a color tone of at least the part of the image, and a display mode for enlarging at least the part of the image.

13. The control device as claimed in claim 1, wherein the display part sets brightness of at least the part of the image for guiding a change of a traveling direction to be higher at a current location of the moving body being a second point before a predetermined distance from a first point, the first point being a point at which the traveling direction of the moving body changes in a route from the current location of the moving body to a predetermined destination.

14. The control device as claimed in claim 13, wherein
the image includes a first object for guiding the change of the traveling direction and a second object indicating the second point; and
the display part is configured to
display the second object at a position overlapping the second point in an environment outside the moving body in response to the current location of the moving body being a point before the second point in the route; and
display the second object at a position corresponding to a position of the first object in response to the current location of the moving body ahead of the second point in the route.

15. The control device as claimed in claim 1, wherein:
the image includes a first object of a first type and a second object of a second type; and
the display part is configured to
display the second object of the second type with the first brightness in response to brightness of the first object being less than a first threshold, and
display the second object of the second type with a third brightness being lower than the first brightness in response to the brightness of the first object of the first type being not less than the first threshold.

16. A display device, comprising:
the control device of claim 1.

17. A display system, comprising:
the display device as claimed in claim 16; and
a brightness sensor configured to detect brightness outside a moving body.

18. A moving body, comprising:
the display device of claim 16.

19. A control method conducted by a control device for controlling a display of an image to be displayed at a position where the image is overlapped on an environment outside a moving body from a view of an occupant of the moving body, the control method comprising:
changing between a first case and a second case in response to brightness outside the moving body, the first case being for displaying at least a part of the image with a first brightness and in a first display mode, and the second case being for displaying at least a part of the image with a second brightness and in a second display mode.

20. A non-transitory computer-readable recording medium storing a program that causes a control device, which controls a display of an image to be displayed at a position where the image is overlapped on an environment outside a moving body from a view of an occupant of the moving body, to perform a process comprising:
changing between a first case and a second case in response to brightness outside the moving body, the first case being for displaying at least a part of the image with a first brightness and in a first display mode, and the second case being for displaying at least a part of the image with a second brightness and in a second display mode.
